(19) United States
(12) Patent Application Publication
(10) Pub. No.: US 2009/0229433 A1
(43) Pub. Date: Sep. 17, 2009

(54) Cutting Tool and Construction Equipment Therfore

(76) Inventors: Elijah Kovalenko, Powhatan, VA (US); Yevgeny Kovalenko, Eureka, MT (US)

Correspondence Address: GOODMAN, ALLEN & FILETTI PLLC, 4501 HIGHWOODS PARKWAY, SUITE 210, GLEN ALLEN, VA, 23060, US

(21) Appl. No.: 12/403,613

(22) Filed: Mar. 13, 2009

Related U.S. Application Data
(60) Provisional application No. 61/069,166, filed on Mar. 13, 2008.

(51) Int. Cl. B26D 3/00; E02F 3/96

(52) U.S. Cl. 83/13; 37/406

(57) ABSTRACT

The invention involves the union of a cutting tool with a non-cutting implement from the following: a bucket with grabbing means, a grapple, a contractors grapple, a stump-splitter-pincher, a root rake with grapple(s), and forks with grapple(s). The union of a cutting tool with one of the non-cutting implements can reside on an articulating arm of equipment. The attachment of the cutting tool can be in the form of an appendage that shares the pin(s) on which the very implements reside and are being manipulated about. The cutting tool is not limited to cutting with teeth. The cutting tool includes any cutting tool that cuts matter.

### CROSS-REFFERENCE TO RELATED APPLICATIONS

This application claims the benefit of U.S. Provisional Application No. 61/069,166 filed Mar. 13, 2008, the disclosure of which is incorporated herein by reference.

### BACKGROUND OF THE INVENTION

This invention relates in general to construction equipment and more particularly to a cutting tool for construction equipment.

Such construction equipment may include, for example, an excavator comprising an articulated arm, commonly referred to as a boom or stick, a bucket and cab mounted on a pivot (i.e., a rotating platform) atop an undercarriage with tracks or wheels. Cutting implements for construction equipment are well known (e.g., a saw head implement, a processor head implement, a log-forestry-grapple-saw implement, etc) and are popular in forestry equipment. These cutting implements can be considered as self-contained units because they comprise their own cutting tool and levers to pinch material while it is cut. The attachment of a known cutting implement onto construction equipment requires the removal of some other non-cutting implement (e.g., digging implement, 4-in-1 bucket, etc). The problem with this mounting arrangement often arises when the removed non-cutting implement is essential to operation. For example, an excavator will loose its digging utility when the bucket is replaced with a forestry processor head implement.

Even though a saw head implement, a processor head implement, etc. come as self-contained implements with their own grabbing levers, they are impractical for sorting and moving diverse materials because they are cumbersome and are designed for specific manipulations. For example, a log grapple, used in forestry, with the bar-and-chain cutter, is used to sort and cut timbers. This implement can be bulky in sorting because the cutter is mounted on its side. Also, this implement lacks the digging utility of a bucket or the rigidity and smashing capability of a contractors grapple because its grapples dangle and swivel helplessly via delicate attachment. Also, because of the cutting tool's arrangement on the side of the knuckle the tool, it often gets smashed against the logs.

Construction equipment with non-cutting implements do not have cutting capability and, when necessity arises, they require a man or a specialized cutting-equipment to do the cutting for them. These non-cutting implements are as follows: a thumb-and-bucket; an earth manipulating bucket, shovel, or the like; a plurality of buckets that can move to oppose each other so as to pinch material; a contractors grapple; a stump-splitter-pincher; a root rake with grapple(s); any grapple; and forks with grapple(s). What is needed is a cutting tool for use with the aforementioned non-cutting implements.

### SUMMARY OF THE INVENTION

This invention relates to construction equipment of various types (e.g., an excavator, wheeled or tracked loader, skid steer, or any equipment) comprising a cutting tool and one of the commonly available non-cutting implements. The non-cutting implements may be narrowed, for example, to an earth digging or manipulating bucket and the like, a contractors grapple, a grapple, a stump-splitter-pincher, a root rake with grapple(s), or to forks with grapple(s).

The attachment of the cutting tool with the non-cutting implements may be in the form of an appendage on the arm of the equipment that shares the pin(s) on which the very implements reside and are being manipulated about. The attachment schemes of the cutting tool in relation to the aforementioned non-cutting implements can differ on construction equipment in various working environments to allow unhindered use of the non-cutting implements when the cutting tool is idle. As a common sense precaution, the cutting tool may be aligned to cut clear away from the non-cutting implements, so as not to damage them.

The union of a cutting tool with the aforementioned non-cutting implements will improve versatility of construction equipment in applicable construction or industrial settings. It will allow clearing companies to grab and cut long pieces of various materials to make the pieces shorter for easier manipulation, such as relocating and transportation. During construction, the aforementioned equipment equipped with a cutting tool will enable safe and fast cutting of material to predetermined lengths (e.g. drainage pipes, timber, wire, etc.). Risk of accidents in various settings will be reduced due to a shorter material manipulation, removed necessity of a person to interact with heavy construction equipment, etc.

Various advantages of this invention will become apparent to those skilled in the art from the following detailed description of the preferred embodiment, when read in light of the accompanying drawings.

### BRIEF DESCRIPTION OF THE DRAWING

FIG. 1 is a partial side elevation of construction equipment with a cutting tool mounted thereto.

FIG. 2 is an environmental, rear elevation of the construction equipment and a cutting tool shown in FIG. 1.

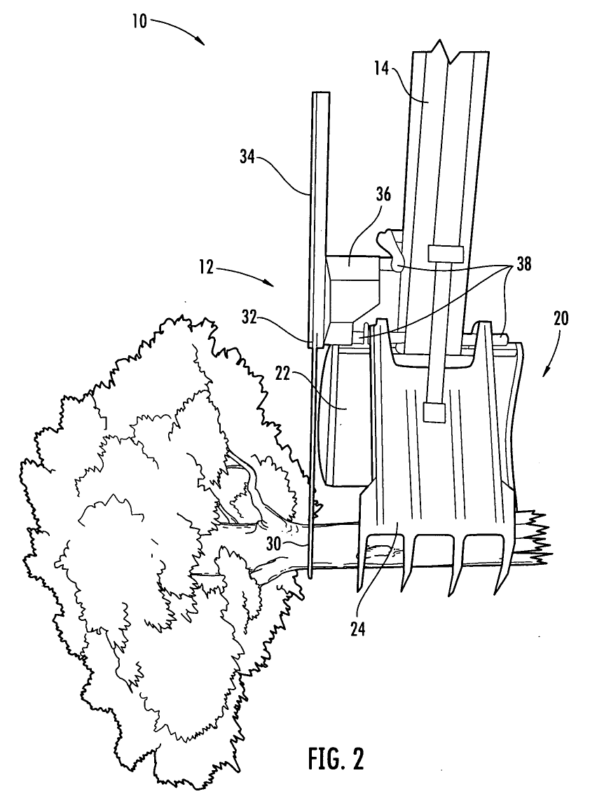

### DETAILED DESCRIPTION OF THE PREFFERED EMBODIMENT

Referring now to the drawings, there is illustrated a portion of construction equipment, indicated generally at 10, with a cutting tool 12 mounted thereto. The construction equipment comprises an articulated arm 14. The arm 14 supports a grapple 20, in the form of a claw having two or more opposing levers, such as the bucket and the thumb 22, 24 shown, that pinch a log or other material, usually to catch, lift, hold or drag the material. The cutting tool 12 may be actuated when the bucket 22 and the thumb 24 grab the material.

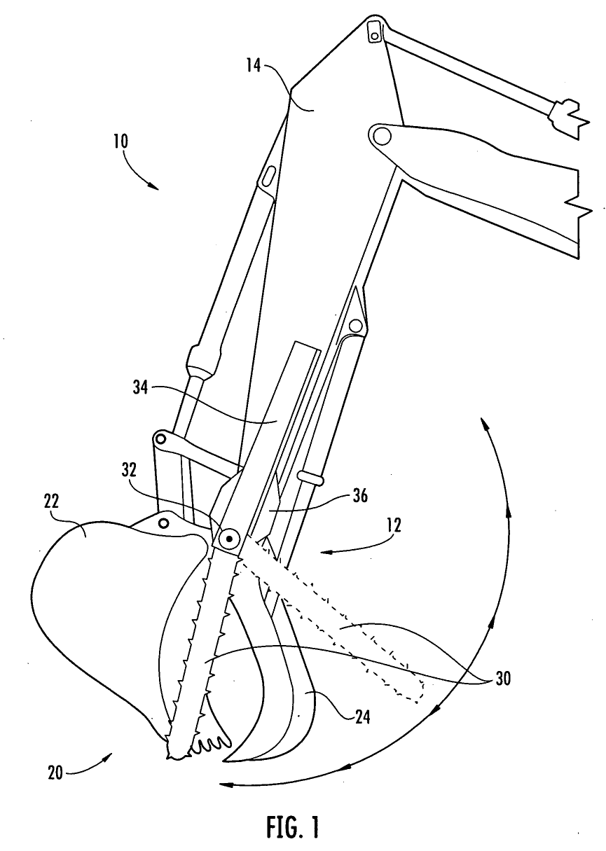

It should be appreciated that the cutting tool 12 may include a cutter 30. The cutter 30, such as the bar-and-chain shown, may be fixed, for example, in relation to the arm 14 or grapple 20. Alternatively, the cutter 30 may be supported for movement in relation to the arm 14 or grapple 20. For example, the cutter 30 may move (e.g., about 180 degrees) along the path of the arrows shown in FIG. 1 at the pivot 32 shown. A shield 34 may be provided. The cutter 30 may extend from and retract into the shield 34 when the cutter 30 is idle. The cutting tool 12 may further be provided with a drive assembly, which may be housed, for example, in the housing 36 shown. The drive assembly may be powered by a power source and connected to the cutter 30 to impart a motive force to the cutter 30, or otherwise operate the cutter 30.

The invention is not intended to be used exclusively with the construction equipment and the grapple 20 shown, but may be used with other levers (i.e., a contractors grapple, a stump-splitter-pincher, four-in-one bucket, clam bucket, forks with grapple(s), root rake with grapple(s), and the like). The reader should appreciate the drawing and references are provided to understand the main concept. From here on, a description of the preferred embodiment will continue, and refer to drawings when necessity arises.

Due to advances in cutting technology, it is now practical to fit the equipment with a grapple 20, as shown, or the other levers (i.e., a contractors bucket, a stump-splitter-pincher, etc.) with various cutters 30. The cutting ability will allow clearing companies to grab and cut long pieces of various materials to make the pieces shorter for easier manipulation, such as relocating and transportation. During construction, the aforementioned equipment equipped with the cutting tool 12 will enable safe and fast cutting of material (e.g. drainage pipes, timbers, logs, wire, and other material) to predetermined lengths.

Continuing with reference to the drawings, the cutting tool 12 may comprise any cutter 30, including, for example, a blade, or a bar-and-chain (as shown), or other cutters (e.g., common torch, plasma, laser, laser emitting element, abrasive-jet, high pressure nozzle), or a setup that cuts universally different material types. Also, multiple cutting tools 12 or cutters 30 can be installed on the arm 14 of the equipment 10 to cut various materials. The cutter 30 or other suitable cutter will add cutting capability to the aforementioned equipment without a noticeable tradeoff or reduction in standard performance because of the reduced size, speed, efficiency, and versatility in available cutting technology. Cutting fluid tanks (e.g., carrying lubricants, coolants, carrying mediums, abrasives, gas/gasses, etc.) may be combined with the cutting tool 12 or cutter 30, or may be placed elsewhere on the arm 14 or the equipment if size is of concern or the placement of these tanks on the cutting tool 12 or cutter 30 is unsafe or undesirable.

Fastening of the cutting tool 12 onto the existing pin(s) 38 on the equipment is beneficial. The existing pin(s) are the pin(s) that hold the grapple 20 (i.e., the grabbing, picking, earth manipulating implements, or other levers 22, 24) on the arm 14 of the equipment. Alternatively, the existing pin(s) 38 may be replaced with prefabricated pin(s). The prefabricated pin(s) may be elongated at least on one side and in some cases on both sides when applicable. As an option, customers can install elongated pins with their elongations on opposing sides of the arm 14 of the equipment to permit the cutting tool 12 to be attached at either side of the arm 14. The elongations may have mating surfaces onto which the cutting tool 12 may be fitted, or onto which an optional quick-attach base (not shown) can be fitted.

The cutting tool 12 on its own can be installed and removed quickly, but the quick attach base may have an advantage because of greater versatility and speed of installation or removal. When the cutting tool 12 is taken off the base, the base by itself may be of slim design. The base may have neatly arranged block of hydraulic or electrical couplers or connectors, respectively. The cutting tool 12 can also be attached on a semi-flexible attachment. This setup will help protect the cutting tool 12 in case it is accidentally bumped, in that it will flex to either side and reduce the blow, thus potentially saving itself from destruction. The choices of the semi-flexible attachment setups (e.g., springs, flexible material, engineering solutions, etc.), which will enable the cutting tool 12 to return to its correct position as soon as the unintended force on the cutting tool 12 recedes, are limitless.

Safety should be of great concern when operating the cutting tool 12. Debris, pieces, or other cutting material may fly out. Thus, it may be necessary to provide sufficient guards or deflectors to reduce the risk that this will occur. The safety guards may be in the way of operation and get torn off. Thus, easily replaceable guards may be considered. Also, setting up the cutting tool 12 in such a way where the cutting material stream flies underneath, for example, a loader 10 or other equipment can be considered in cases where it is applicable. For instance, equipment in the form of an excavator with the boom or arm 14 extended out further away from the cab (not shown) can have a tendency to deflect cutting material debris towards the cab. In this example, the excavator can have an option (if equipped with such versatile cutter) to swing the cutter 30 both ways, that is, to cut the material from the top or from the bottom. This configuration would allow the operator to choose which direction the cutting debris is directed. This versatile cutting approach would have a minimal to nonexistent loss in performance.

Bystanders and crew members are often found working in close vicinity of the equipment (e.g., when hooking up a lifting chain on a loader or an excavator). A laborer on the ground should have a reliable way to disable the cutting tool 12 from outside of the equipment. Once the cutting tool 12 is disabled, an operator inside the equipment will have no way to activate it from inside. This precaution will reduce the risk of accidents due to a short in the system or unintended use of the cutting tool 12. Disabling the cutting tool 12 should be easy to reach from the ground and should not require a laborer to put oneself at extra risk. For example, a laborer need not be reaching or getting any part(s) of his/her body between the levers 22, 24 (e.g., a contractors grapple, a stump-splitter-pincher, or forks with grapple(s) and the like) of a wheeled or tracked equipment.

One way of easy access to the disabling mechanism (not shown) is the placement of an antenna-type rod with a push-button at its end, on one or both sides of the equipment 10. The disabling button may turn off the power supply to the cutting tool 12, which may be electrical, hydraulic, mechanical, or any imaginable alternative power source. As the cutting tool 12 is turned off, the disabling mechanism may send a confirmation signal (e.g., sound blip or light). Furthermore, the operator or the laborer outside should be able to know if the cutting tool 12 is disabled just by looking at coded signals. Another way is a conventional approach that can be very reliable and economical. This method may use purely manual means of locking or disabling the cutting tool 12, for example, a pin that would slide through, for example, the cutting-bar 30 and the housing 36 to lock the cutting tool 12 in its place. Due to the cutting tool's agility (speed), safety should be of greatest concern when working near it. Also, servicing, installing, uninstalling a cutting tool 12 should be done by a certified person with references to various manuals.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. Construction equipment comprising:
an articulated arm supporting a non-cutting implement that is operable to manipulate material; and
a cutting tool mounted to the articulated arm, the cutting tool being operable to cut the material while the non-cutting implement manipulates the material.

2. The construction equipment of claim 1, wherein the articulated arm has sides and the cutting tool is mounted on any side of the articulated arm.

3. The construction equipment of claim 1, wherein the non-cutting implement comprises opposing levers that comprise a bucket and a thumb forming of a claw.

4. The construction equipment of claim 1, wherein the non-cutting implement comprises a plurality or opposing buckets that are operable to open and close in relation to one another.

5. The construction equipment of claim 1, wherein the non-cutting implement comprises a four-in-one bucket.

6. The construction equipment of claim 1, wherein the non-cutting implement comprises a contractors grapple.

7. The construction equipment of claim 1, wherein the non-cutting implement comprises a root-rake with one or more grapples.

8. The construction equipment of claim 1, wherein the non-cutting implement comprises forks with one or more grapples.

9. The construction equipment of claim 1, wherein the cutting tool is one of a plurality of cutting tools mounted to the arm, the cutting tools being selectively operable depending upon the material being cut.

10. The construction equipment of claim 1, wherein the cutting tool comprises one or more of a blade, a bar-and-chain, a torch, plasma, a laser, or an abrasive-jet.

11. The construction equipment of claim 1, further comprising one or more fluid carriers for carrying cutting fluids for use in combination with the cutting tool.

12. The construction equipment of claim 1, wherein the cutting tool is mounted to the articulated arm via one or more pins.

13. The construction equipment of claim 12, wherein the one or more pins support the non-cutting implement.

14. The construction equipment of claim 12, wherein the one or more pins are structured and dimensioned to be installed to permit the cutting tool to be supported at either side of the articulated arm or the non-cutting implement.

15. The construction equipment of claim 1, further comprising a quick attach base for speed of mounting or removal of the cutting tool.

16. The construction equipment of claim 15, wherein the base comprises one or more hydraulic couplers or electrical connectors for connecting the cutting tool to a power source.

17. The construction equipment of claim 1, wherein the cutting tool comprises a semi-flexible attachment to protect the cutting tool against the risk of damage if accidentally bumped.

18. The construction equipment of claim 17, wherein the semi-flexible attachment comprises one or more springs or flexible materials.

19. A method of cutting material comprising the steps of:
a) providing construction equipment comprising an articulated arm,
b) supporting a non-cutting implement in relation to the arm,
c) articulating the non-cutting implement to manipulate material;
d) mounting a cutting tool to the arm, and
e) operating the cutting tool to actuate the cutting tool to cut the material while the non-cutting implement manipulate the material.

20. The method of claim 19, wherein in step e), the non-cutting implement comprises levers that grab the material and cutting tool cuts the material from long pieces to make the pieces shorter.

21. The method of claim 20, further comprising the step of manipulating the short pieces.

22. The method of claim 21, wherein the manipulating step comprises at least one of the steps of relocating or transporting the short pieces.

23. The method of claim 19, wherein the cutting tool in step d) comprises one or more of a blade, a bar-and-chain, a torch, plasma, a laser, or an abrasive-jet.

24. The method of claim 19, further comprising the step of providing one or more cutting fluids in combination with the cutter.
